(19) United States
(12) Patent Application Publication
(10) Pub. No.: US 2012/0158183 A1
(43) Pub. Date: Jun. 21, 2012

(54) WALKING ROBOT AND CONTROL METHOD THEREOF

(75) Inventors: Bok Man LIM, Seoul (KR); Kyung Shik Roh, Seongnam-si (KR); Woong Kwon, Seongnam-si (KR); Min Hyung Lee, Anyang-si (KR)

(73) Assignee: Samsung Electronics Co., Ltd., Suwon-si (KR)

(21) Appl. No.: 13/283,761

(22) Filed: Oct. 28, 2011

(30) Foreign Application Priority Data
Dec. 21, 2010 (KR) 10-2010-0131263

(51) Int. Cl. G05B 15/00

(52) U.S. Cl. 700/261

(57) ABSTRACT

A robot which naturally walks with high energy efficiency similar to a human through optimization of actuated dynamic walking, and a control method thereof. The control method includes defining a plurality of unit walking motions, in which stride, velocity, rotating angle and direction of the robot are designated, through combination of parameters to generate target joint paths, and constructing a database in which the plurality of unit walking motions is stored, setting an objective path up to an objective position, performing interpretation of the objective path as unit walking motions, generating walking patterns consisting of at least one unit walking motion to cause the robot to walk along the objective path based on the interpretation of the objective path, and allowing the robot to walk based on the walking patterns.

### CROSS-REFERENCE TO RELATED APPLICATION

This application claims the benefit of Korean Patent Application No. 2010-0131263, filed on Dec. 21, 2010 in the Korean Intellectual Property Office, the disclosure of which is incorporated herein by reference.

### BACKGROUND

1. Field

Embodiments relate to a walking robot which walks according to torque control-based dynamic walking, and a control method thereof.

2. Description of the Related Art

In general, research and development of walking robots which have a joint system similar to that of humans and coexist with humans in human working and living spaces is actively progressing. The walking robots are multi-legged walking robots having a plurality of legs, such as two or three legs or more, and in order to achieve stable walking of the robot, actuators, such as electric motors or hydraulic motors, located at respective joints of the robot need to be driven. As methods to drive these actuators, there are a position-based Zero Moment Point (hereinafter, referred to as ZMP) control method in which command angles of respective joints, i.e., command positions, are given and the joints are controlled so as to track the command positions, and a torque-based Finite State Machine (hereinafter, referred to as FSM) control method in which command torques of respective joints are given and the joints are controlled so as to track the command torques.

In the ZMP control method, walking direction, stride, and walking velocity of a robot are set in advance so as to satisfy a ZMP constraint. As an example, a ZMP constraint may be a condition that a ZMP is present in a safety region within a support polygon formed by a supporting leg(s) (if the robot is supported by one leg, this means the region of the leg, and if the robot is supported by two legs, this means a region set to have a small area within a convex polygon including the regions of the two legs in consideration of safety). Walking patterns of the respective legs corresponding to the set factors are generated, and walking trajectories of the respective legs are calculated based on the walking patterns. Further, angles of joints of the respective legs are calculated through inverse kinematics of the calculated walking trajectories, and target control values of the respective joints are calculated based on current angles and target angles of the respective joints. Moreover, servo control allowing the respective legs to track the calculated walking trajectories per control time is carried out. That is, during walking of the robot, whether or not positions of the respective joints precisely track the walking trajectories according to the walking patterns is detected, and if it is detected that the respective legs deviate from the walking trajectories, torques of the motors are adjusted so that the respective legs precisely track the walking trajectories. The ZMP control method is a position-based control method and thus achieves precise position control, but needs to perform precise angle control of the respective joints in order to control the ZMP and thus requires high servo gain. Thereby, the ZMP control method requires high current and thus has low energy efficiency and high stiffness of the joints.

On the other hand, in the FSM control method, instead of tracking positions per control time, a finite number of operating states (herein, the states mean states in a finite state machine) of a robot is defined in advance, target torques of respective joints are calculated with reference to the respective operating states during walking, and the joints are controlled so as to track the target torques. The FSM control method controls torques of the respective torques during walking, and thus requires low servo gain and has high energy efficiency and low stiffness of the joints. Further, the FSM control method does not need to avoid kinematic singularities, thus allowing the robot to have a natural gait in the same manner as that of a human.

Actuated dynamic walking is not a position-based control method but is a torque-based control method, thus having high energy efficiency and allowing a robot to have a natural gait in the same manner as that of a human. However, the actuated dynamic walking does not carry out precise position control, thus having difficulty in precisely controlling stride or walking velocity. Further, differing from the position-based control method, the actuated dynamic walking plans walking patterns directly in a joint space, thus having difficulty in generating a walking pattern having desired stride, velocity and direction.

### SUMMARY

Therefore, it is an aspect of an embodiment to provide a robot which generates a walking pattern having desired stride, velocity and direction through optimization of actuated dynamic walking and walks based on the walking pattern so as to naturally walk with high energy efficiency similar to a human, and a control method thereof.

Additional aspects of embodiments will be set forth in part in the description which follows and, in part, will be obvious from the description, or may be learned by practice of embodiments.

In accordance with an aspect of an embodiment, a control method of a walking robot includes defining a plurality of unit walking motions, in which stride, velocity, rotating angle and direction of the robot are designated, through combination of parameters to generate target joint paths, and constructing a database in which the plurality of unit walking motions is stored, setting an objective path up to an objective position, performing interpretation of the objective path as unit walking motions, generating walking patterns consisting of at least one unit walking motion to cause the robot to walk along the objective path based on the interpretation of the objective path, and allowing the robot to walk based on the walking patterns.

In the control method, the walking of the robot may be torque control-based dynamic walking.

In the control method, the parameters to determine the target joint paths may include at least one of a parameter indicating left and right movement of hip joints of the robot, a parameter indicating inclination of a torso of the robot, a parameter indicating a stride length of the robot, a parameter indicating a bending angle of knees of the robot, a parameter indicating a walking velocity of the robot, a parameter indicating movement of ankles of the robot in the y-axis direction, a parameter indicating an initial state of the left and right movement of the hip joints of the robot, and a parameter indicating an initial state of the stride of the robot.

In the control method, the walking patterns may include a broad walking pattern generated in consideration of the entirety of the objective path, and a local walking pattern forming a part of the broad walking pattern.

In the control method, the broad walking pattern may be a walking pattern generated in consideration of avoidance of a static obstacle recognized in advance.

In the control method, the local walking pattern may be a walking pattern generated in consideration of avoidance of a new obstacle recognized during walking of the robot along the broad walking pattern.

In the control method, the local walking pattern may be generated by combining unit walking motions necessary to avoid the new obstacle from among the plurality of unit walking motions stored in the database.

In accordance with another aspect of an embodiment, a walking robot includes a plurality of joints to achieve walking of the robot, a database in which a plurality of unit walking motions, in which stride, velocity, rotating angle and direction of the robot are designated, is defined through combination of parameters to generate target joint paths, and a control unit to control the plurality of joints by setting an objective path up to an objective position, performing interpretation of the objective path as unit walking motions, generating walking patterns consisting of at least one unit walking motion to cause the robot to walk along the objective path based on the interpretation of the objective path, and allowing the robot to walk based on the walking patterns.

In the walking robot, the walking of the robot may be torque control-based dynamic walking.

In the walking robot, the parameters to determine the target joint paths may include at least one of a parameter indicating left and right movement of hip joints of the robot, a parameter indicating inclination of a torso of the robot, a parameter indicating a stride length of the robot, a parameter indicating a bending angle of knees of the robot, a parameter indicating a walking velocity of the robot, a parameter indicating movement of ankles of the robot in the y-axis direction, a parameter indicating an initial state of the left and right movement of the hip joints of the robot, and a parameter indicating an initial state of the stride of the robot.

In the walking robot, the walking patterns may include a broad walking pattern generated in consideration of the entirety of the objective path, and a local walking pattern forming a part of the broad walking pattern.

In the walking robot, the broad walking pattern may be a walking pattern generated in consideration of avoidance of a static obstacle recognized in advance.

In the walking robot, the local walking pattern may be a walking pattern generated in consideration of avoidance of a new obstacle recognized during walking of the robot along the broad walking pattern.

In the walking robot, the local walking pattern may be generated by combining unit walking motions necessary to avoid the new obstacle from among the plurality of unit walking motions stored in the database.

### BRIEF DESCRIPTION OF THE DRAWINGS

These and/or other aspects of embodiments will become apparent and more readily appreciated from the following description of the embodiments, taken in conjunction with the accompanying drawings of which:

FIG. 1 is a view illustrating an external appearance of a robot in accordance with an embodiment;

FIG. 2 is a view illustrating main joint structures of the robot shown in FIG. 1;

FIG. 3 is a view illustrating operating states of the robot and control actions of the respective operating states, while the robot in accordance with an embodiment walks based on an FSM control method;

FIG. 4 is a walking control block diagram of the robot in accordance with an embodiment;

FIGS. 5A to 5C are conceptual views illustrating movements of joints of the robot in accordance with an embodiment in the x-axis and y-axis directions;

FIG. 6 is a graph illustrating paths of hip joint units of the robot in accordance with an embodiment;

FIGS. 7A and 7B are views illustrating a walking control concept of the robot in accordance with an embodiment; and

FIG. 8 is a flow chart illustrating a walking control method of the robot in accordance with an embodiment.

### DETAILED DESCRIPTION

Reference will now be made in detail to embodiments, examples of which are illustrated in the accompanying drawings, wherein like reference numerals refer to like elements throughout.

Hereinafter, among multi-legged walking robots, a bipedal walking robot will be exemplarily described.

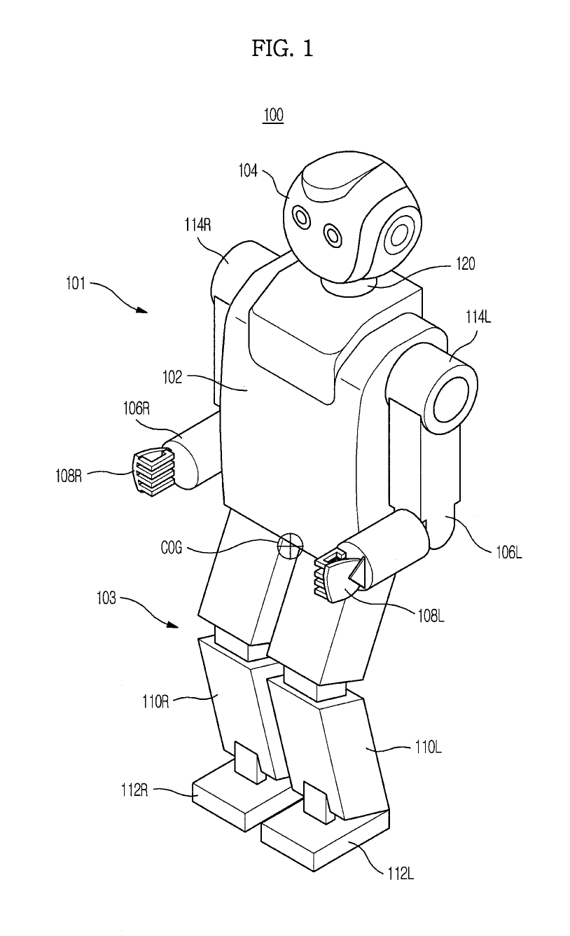

FIG. 1 is a view illustrating an external appearance of a robot in accordance with an embodiment.

As shown in FIG. 1, a robot 100 is a bipedal walking robot, which walks erect with two legs 110R and 110L in the same manner as a human, and includes an upper body 101 including a torso 102, a head 104 and arms 106R and 106L, and a lower body 103 including the two legs 110R and 110L.

The upper body 101 of the robot 100 includes the torso 102, the head 104 connected to the upper portion of the torso 102 through a neck 120, the two arms 106R and 106L connected to both sides of the upper portion of the torso 102 through shoulders 114R and 114L, and hands 108R and 108L respectively connected to tips of the two arms 106R and 106L.

The lower body 103 of the robot 100 includes the two legs 110R and 110L connected to both sides of the lower portion of the torso 102 of the upper body 101, and feet 112R and 112L respectively connected to tips of the two legs 110R and 110L.

Here, “R” and “L” respectively indicate the right and left sides of the robot 100, and “COG” indicates the center of gravity of the robot 100.

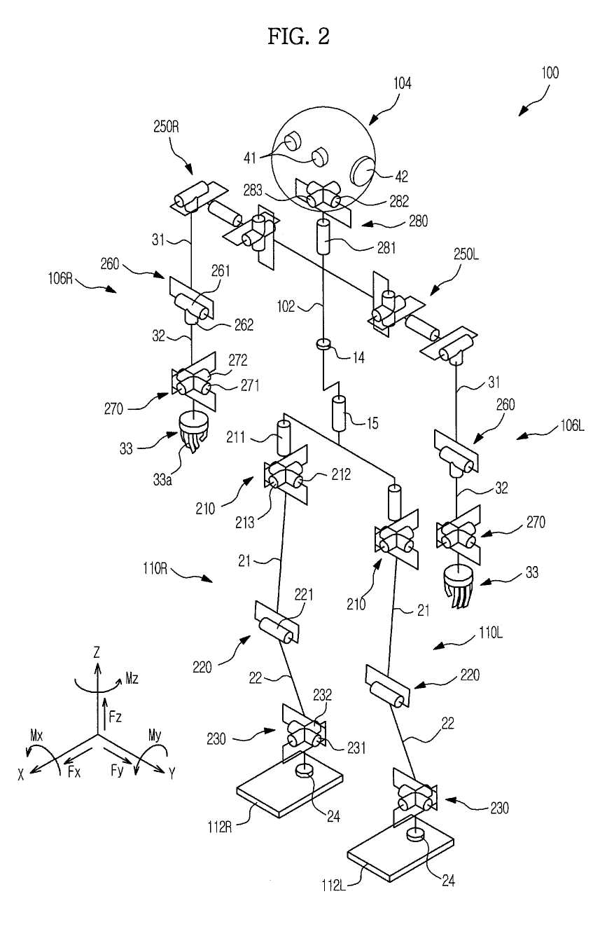

FIG. 2 is a view illustrating main joint structures of the robot shown in FIG. 1.

As shown in FIG. 2, a pose sensor 14 is installed on the torso 102 of the robot 100. The pose sensor 14 detects a tilt angle of the upper body 101, i.e., inclination of the upper body 101 with respect to a vertical axis, and an angular velocity thereof, and then generates pose data. The pose sensor 14 may be installed on the head 104 as well as the torso 102.

A waist joint unit 15 having 1 degree of freedom in the yaw direction so as to rotate the upper body 101 is installed on the torso 102.

Further, cameras 41 to capture surrounding images and microphones 42 for user's voice input are installed on the head 104 of the robot 100.

The head 104 is connected to the torso 102 of the upper body 101 through a neck joint unit 280. The neck joint unit 280 includes a rotary joint 281 in the yaw direction (rotated around the z-axis), a rotary joint 282 in the pitch direction (rotated around the y-axis), and a rotary joint 283 in the roll direction (rotated around the x-axis), and thus has 3 degrees of freedom.

Motors (for example, actuators, such as electric motors or hydraulic motors) to rotate the head 104 are connected to the respective rotary joints 281, 282, and 283 of the neck joint unit 280.

The two arms 106L and 106R of the robot 100 respectively include upper arm links 31, lower arm links 32, and hands 33.

The upper arm links 31 are connected to the upper body 101 through shoulder joint units 250L and 250R, the upper arm links 31 and the lower arm links 32 are connected to each other through elbow joint units 260, and the lower arm links 32 and the hands 33 are connected to each other by wrist joint units 270.

The shoulder joint units 250L and 250R are installed at both sides of the torso 102 of the upper body 101, and connect the two arms 106L and 106R to the torso 102 of the upper body 101.

Each elbow joint unit 260 has a rotary joint 261 in the pitch direction and a rotary joint 262 in the yaw direction, and thus has 2 degrees of freedom.

Each wrist joint unit 270 has a rotary joint 271 in the pitch direction and a rotary joint 272 in the roll direction, and thus has 2 degrees of freedom.

Each hand 33 is provided with five fingers 33a. A plurality of joints (not shown) driven by motors may be installed on the respective fingers 33a. The fingers 33a perform various motions, such as gripping, of an article or pointing in a specific direction, in connection with movement of the arms 106.

The two legs 110L and 110R of the robot 100 respectively include thigh links 21, calf links 22, and the feet 112L and 112R.

The thigh links 21 correspond to thighs of a human and are connected to the torso 102 of the upper body 101 through hip joint units 210, the thigh links 21 and the calf links 22 are connected to each other by knee joint units 220, and the calf links 22 and the feet 112L and 112R are connected to each other by ankle joint units 230.

Each hip joint unit 210 has a rotary joint (hip yaw joint) 211 in the yaw direction (rotated around the z-axis), a rotary joint (hip pitch joint) 212 in the pitch direction (rotated around the y-axis), and a rotary joint (hip roll joint) 213 in the roll direction (rotated around the x-axis), and thus has 3 degrees of freedom.

Each knee joint unit 220 has a rotary joint 221 in the pitch direction, and thus has 1 degree of freedom.

Each ankle joint unit 230 has a rotary joint 231 in the pitch direction and a rotary joint 232 in the roll direction, and thus has 2 degrees of freedom.

Since six rotary joints of the hip joint unit 210, the knee joint unit 220, and the ankle joint unit 230 are provided on each of the two legs 110L and 110R, a total of twelve rotary joints is provided to the two legs 110L and 110R.

Further, multi-axis force and torque (F/T) sensors 24 are respectively installed between the feet 112L and 112R and the ankle joint units 230 of the two legs 110L and 110R. The multi-axis F/T sensors 24 measure three-directional components Fx, Fy, and Fz of force and three-directional components Mx, My, and Mz of moment transmitted from the feet 112L and 112R, thereby detecting whether or not the feet 112L and 112R touch the ground and load applied to the feet 112L and 112R.

Although not shown in the drawings, actuators, such as motors, to drive the respective rotary joints are installed on the robot 100. A control unit to control the overall operation of the robot 100 properly controls the motors, thereby allowing the robot 100 to perform various motions.

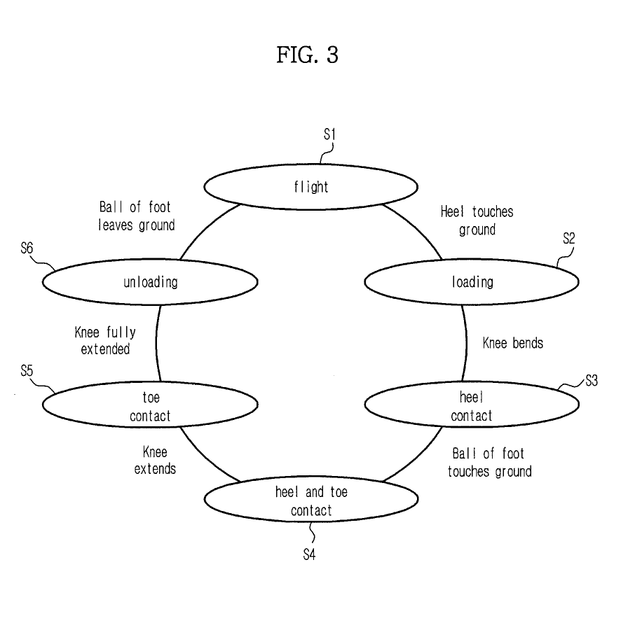

FIG. 3 is a view illustrating operating states of the robot and control actions of the respective operating states, while the robot in accordance with an embodiment walks based on the FSM control method.

With reference to FIG. 3, in the torque-based FSM control method, operation of the robot 100 is divided into a plurality of operating states (for example, 6 states of S1, S2, S3, S4, S5, and S6), which are defined in advance. The respective operating states S1, S2, S3, S4, S5, and S6 indicate poses of one leg 110L or 110R of the robot 100 during walking, and stable walking of the robot 100 is achieved by proper transition between such poses of the robot 100.

The first operating state (flight state) S1 corresponds to a pose of swinging the leg 110L or 110R, the second operating state (loading state) S2 corresponds to a pose of loading the foot 112 on the ground, the third operating state (heel contact state) S3 corresponds to a pose of bringing the heel of the foot 112 into contact with the ground, the fourth operating state (heel and toe contact state) S4 corresponds to a pose of bringing both the heel and the toe of the foot 112 into contact with the ground, the fifth operating state (toe contact state) S5 corresponds to a pose of bringing the toe of the foot 112 into contact with the ground, and the sixth operating state (unloading state) S6 corresponds to a pose of unloading the foot 112 from the ground.

In order to transition from one operating state to another operating state, a control action to achieve such transition is required.

In more detail, if the first operating state S1 transitions to the second operating state S2 (S1→S2), a control action in which the heel of the foot 112 touches the ground is required.

If the second operating state S2 transitions to the third operating state S3 (S2→S3), a control action in which the knee (particularly, the knee joint unit) of the foot 112 touching the ground bends is required.

If the third operating state S3 transitions to the fourth operating state S4 (S3→S4), a control action in which the ball of the foot 112 touches the ground is required.

If the fourth operating state S4 transitions to the fifth operating state S5 (S4→S5), a control action in which the knee of the foot 112 touching the ground extends is required.

If the fifth operating state S5 transitions to the sixth operating state S6 (S4→S5), a control action in which the knee of the foot 112 touching the ground fully extends is required.

If the sixth operating state S6 transitions to the first operating state S1 (S6→S1), a control action in which the ball of the foot 112 leaves the ground is required.

Therefore, in order to perform the control actions, the robot 100 calculates torque commands of the respective joints corresponding to the respective control actions, and outputs the calculated torque commands to the actuators, such as the motors, installed on the respective joints to drive the actuators.

In such a torque-based FSM control method, walking of the robot 100 is controlled depending on the operating states S1, S2, S3, S4, S5, and S6, defined in advance.

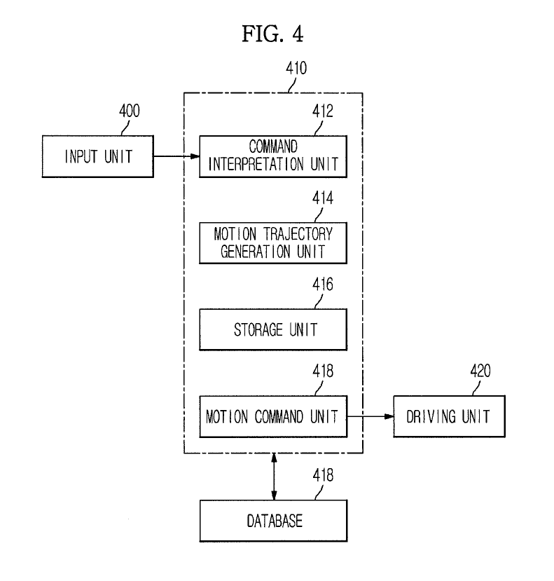

FIG. 4 is a walking control block diagram of the robot in accordance with an embodiment.

As shown in FIG. 4, the robot 100 includes an input unit 400 through which the robot 100 receives a walking command, etc. from a user, a control unit 410 to perform overall control of the robot 100 according to an action command received through the input unit 400, and a driving unit 420 to drive respective joints of the robot 100 according to a control signal from the control unit 410.

The control unit 410 to control the overall operation of the robot 100 includes a command interpretation unit 412, a motion trajectory generation unit 414, a storage unit 416, and a motion command unit 418. Particularly, the control unit 410 controls the respective joints of the robot 100 so as to generate walking patterns of the robot 100 and to allow the robot 100 to walk according to the walking patterns.

The command interpretation unit 412 interprets the action command received through the input unit 400, and recognizes robot parts which perform a main motion having high relevance to a commanded action and robot parts which perform remaining motions having low relevance to the commanded action, respectively.

The motion trajectory generation unit 414 generates optimized motion trajectories for the robot parts performing the main motion among the robot parts recognized by the command interpretation unit 412 through optimization in consideration of robot dynamics, and generates predetermined motion trajectories for the robot parts performing the remaining motions so as to correspond to the commanded action. Here, each motion trajectory is one of joint trajectories, link trajectories, and end-effecter (for example, finger tip or toe tip) trajectories.

The storage unit 416 divisionally stores the robot parts performing the main motion having high relevance to the commanded action and the robot parts performing the remaining motions having low relevance to the commanded action according to respective action commands, and stores predetermined motion trajectories so as to correspond to the commanded action according to the respective action commands.

The motion command unit 418 outputs a motion command, causing the robot parts performing the main motion to move along the optimized motion trajectories generated by the motion trajectory generation unit 141, to the corresponding driving units 420 and thus controls operation of the driving units 420, and outputs a motion command, causing the robot parts performing the remaining motions to move along the predetermined motion trajectories corresponding to the commanded action generated by the motion trajectory generation unit 141, to the corresponding driving units 420 and thus controls operation of the driving units 420.

Hereinafter, an optimization process of walking of the robot in accordance with an embodiment will be described in detail.

The control unit 410 sets control gain and a plurality of variables, which determine paths of target joints to be controlled during walking of the robot, as optimization variables.

When all of numerous control variables of the respective joints relating to walking are set as the optimization variables, complexity is increased and thus optimization time and a rate of convergence are lowered.

The minimum number of control variables to determine target joint paths may be set using periodicity in walking and symmetry in swing of legs. The control variables to determine the target joint paths in accordance with this embodiment include a variable (P1=q_hip_roll) indicating left and right movement of the hip joints of the robot, a variable (P2=q_torso) indicating inclination of the torso of the robot, a variable (P3=q_hipsweep) indicating a stride length of the robot, a variable (P4=q_kneebend) indicating a bending angle of the knees of the robot, a variable (P5=tf) indicating a walking velocity of the robot, a variable (P6=q_ankle) indicating movement of the ankles of the robot in the y-axis direction, a variable (P7=q_hip_roll_ini) indicating an initial state of the left and right movement of the hip joints of the robot, and a variable (P8=q_hipsweep-ini) indicating an initial state of the stride of the robot. The variables P7 and P8 are control variables indicating an initial walking pose of the robot. The above-described control variables except for the variable P5 indicating the walking velocity are expressed as angles in the directions of corresponding degrees of freedom of corresponding joints. Although this embodiment describes eight variables to determine the target joint paths, the number of the variables is not limited thereto. Further, the contents of the variables are not limited thereto.

The control unit 410 calculates torque input values by parameterizing Expression to calculate the torque input values using the set optimization variables.

τⁱ=kⁱₚ(qⁱ_{d}−qⁱ)−kⁱ_{d} q̅ⁱ [Expression 1]

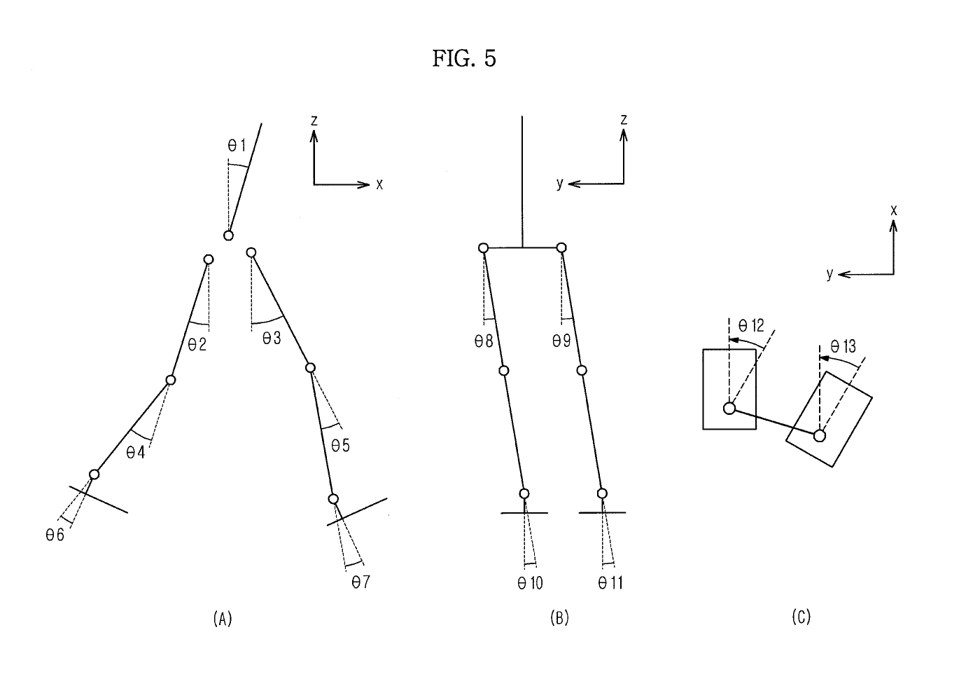

Herein, τ represents a torque input value, and i means each of joints relating to walking, i.e., including a torso joint movable at an angle of θ1 (of FIG. 5A) in the y-axis direction, left and right hip joints movable at angles of θ2 and θ3 (of FIG. 5A) and θ8 and θ9 (of FIG. 5B) in the y-axis direction and the x-axis direction, left and right knee joints movable at angles of θ4 and θ5 (of FIG. 5A) in the y-axis direction, and left and right ankle joints movable at angles of θ6 and θ7 (of FIG. 5A), θ10 and θ11 (of FIG. 5B), and θ12 and θ123 (of FIG. 5C) in the y-axis direction and the x-axis direction.

Further, kp represents position gain, and kd represents damping gain. qd represents a target joint path, q represents a current angle measured by an encoder, and q̅ represents an angular velocity.

The control unit 410 calculates the torque input values through Expression 1 using the control gain and the variables determining the target joint paths, which are set as optimization variables.

The control unit 410 selects plural poses from among continuous poses assumed by the robot during walking of the robot in a half cycle in which the robot makes one step with its one foot to determine the target joint paths, and sets the selected plural poses as reference poses. In this embodiment, the reference poses include a pose when the walking of the robot in the half cycle is started, a pose when the walking of the robot in the half cycle is completed, and a pose halfway between the point of time when the walking of the robot in the half cycle is started and the point of time when the walking of the robot in the half cycle is completed.

The control unit 410 calculates angles of the torso joint, the hip joints, the knee joints, and the ankle joints in the directions of the corresponding degrees of freedom in the respective reference poses, and determines paths of the respective target joints of the robot during walking of the robot in the half cycle through spline interpolation of the calculated angles.

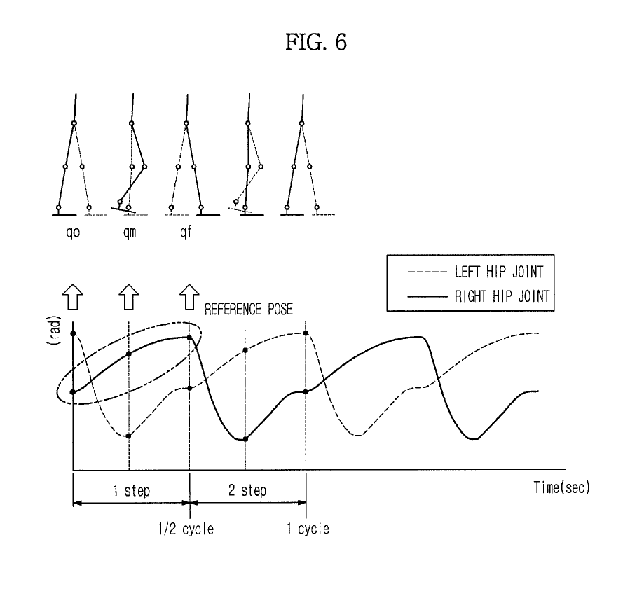

FIG. 6 is a graph illustrating paths of the hip joints among the target joints of the robot in accordance with an embodiment. Angle variations of the hip joints in the y-axis direction in each of the respective reference poses are calculated, and paths of the hip joints of the robot during walking of the robot in the half cycle (indicated by a circle in FIG. 6) are generated through spline interpolation of the calculated angle variations. A solid line indicates the path of the right hip joint, and a dotted line indicates the path of the left hip joint. When the paths during walking of the robot in the half cycle are determined in such a manner, paths during walking of the robot in the remaining walking period may be determined using periodicity in walking and symmetry in leg swing, as shown in FIG. 6.

The control unit 410 sets an objective function J consisting of the sum total of various performance indices to allow the robot to perform natural walking similar to a human with high energy efficiency.

$$\begin{matrix} J = {w}_{1} {J}_{1} + {w}_{2} {J}_{2} + {w}_{3} {J}_{3} + {w}_{4} {J}_{4} + {w}_{5} {J}_{5} & [ Equation 2 ] \\ {J}_{1} = {\sum }_{i = 1}^{n} {‖ {x}_{i} - {x}_{i}^{d} ‖}^{2} \\ {J}_{2} = {\sum }_{i = 1}^{n} {‖ {F}_{i} ‖}^{2} + {\sum }_{i = 3}^{n - 3} ( \begin{matrix}{‖ {F}_{i - 2} - {F}_{i + 1} ‖}^{2} + {‖ {F}_{i} - {F}_{i + 1} ‖}^{2} + \\ {‖ {F}_{i} - {F}_{i + 3} ‖}^{2}\end{matrix} ) \\ {J}_{3} = {‖ v - {v}^{d} ‖}^{2} \\ {J}_{4} = {\sum }_{t = 0}^{{t}_{f}} {‖ {τ}_{i} ( t ) ‖}^{2} \\ {J}_{5} = {( P - {P}_{pred} )}^{T} W ( P - {P}_{pred} ) & [ Equation 3 ]\end{matrix}$$

Expression 2 represents the objective function J consisting of the sum total of plural performance indices J1˜J5 relating to walking of the robot. Coefficients preceding the performance indices mean weights assigned to apply importance to the respective performance indices.

The control unit 410 checks whether or not a value of the objective function J satisfies a convergence condition. The convergence condition is satisfied if a difference between the current value of the objective function and a value of the objective function calculated in the previous process is less than a designated value. Here, the designated value may be predetermined by a user. The control unit 410 makes the value of the objective function to satisfy the convergence condition, thereby allowing the robot to perform natural walking similar to a human with high energy efficiency.

Expression 3 represents the respective performance indices of the objective function.

J₁ is a performance index indicating a position error of a foot of the robot contacting the ground, x represents an actual position of the foot contacting the ground, x_{d} represents an objective position of the foot contacting the ground, and i represents the number of steps (hereinafter, the same). J₁ is a difference between the actual position and the objective position of the foot, and thus represents the position error of the foot.

In J₂, F represents force applied to the foot of the robot when the foot of the robot contacts the ground. The first term in J₂ represents force applied to the foot of the robot when the foot of the robot contacts the ground, and the second term represents a difference of forces applied to the feet of the robot at respective steps. No difference in forces means that walking of the robot is periodically achieved, and thus J₂ is a performance index indicating a force error applied to the foot of the robot when the foot of the robot contacts the ground and a periodicity error of walking of the robot.

In J₃, v represents an actual walking velocity of the robot, and v^{d} represents an objective walking velocity of the robot. Therefore, J₃ is a performance index indicating a walking velocity error of the robot.

In J₄, τ represents a torque of each of the respective joints required for walking of the robot, and t_{f} represents time to complete planned walking. Therefore, J₄ is a performance index indicating torques required during walking of the robot.

In J₅, P represents a vector consisting of a variable to determine an actual target joint path, and P_{predi} represents a vector consisting of a variable to determine an objective target joint path. T is a mark representing transposition of the vector, W represents a diagonal matrix in which the number of elements of the vector P is expressed in rows and columns, and respective diagonal elements serve as weights applied to the respective elements of the vector. Therefore, J₅ is a performance index indicating a walking style error.

Although this embodiment illustrates the objective function as consisting of five performance indices, the configuration of the objective function is not limited thereto. Further, the performance indices are not limited to the above-described contents and may include other limitations relating to walking of the robot.

The control unit 410 obtains a resultant motion of the robot through calculation of forward dynamics using the torque input values, and calculates the value of the objective function using data of the resultant motion and actual walking of the robot. If the calculated value of the objective function does not satisfy the convergence condition, the control unit 410 adjusts optimization variables several times so that the value of the objective function satisfies the convergence condition.

Table 1 below represents parameters to generate target joint paths in accordance with an embodiment.

TABLE 1

| Description of joint motion | qm | qf |
|---|---|---|
| Torso pitch inclination | p1 | p1 |
| Swing hip yaw for turning | p2 | p2 |
| Swing hip roll shift | p3 | 0 |
| Swing hip pitch sweep | −p4 | −p4 |
| Swing knee pitch bending | p5 | 0 |
| Swing ankle pitch | −p6 | p7 + p4 |
| Swing ankle roll | −p3 | 0 |
| Stance hip yaw for turning | −p2 | −p2 |
| Stance hip roll shift | −p3 | 0 |
| Stance hip pitch | N/A | p4 |
| Stance knee pitch | 0 | 0 |
| Stance ankle pitch | −p7 | −p7 − p4 |
| Stance ankle roll | p3 | 0 |

Unit walking motions A={A1, A2, A3, . . . , An} are defined through combination of the variables to generate target joint paths. Here, n is the total number of the defined unit walking motions. The unit walking motions mean specific walking motions which are defined in advance, and an objective series of walking patterns may be generated by variously combining the unit walking motions. Each unit walking motion is characterized by a size of a stride (p4, calculated as a leg length of the robot), a rotating angle (p2) and a step time (tf). One unit walking motion Ai is defined as {Pr1, Pr2, Pr3, Pr9} (i.e., Ai={Pr1, Pr2, Pr3, Pr9}). Here, Pr1, Pr2, Pr3, . . . Pr9 are referred to as control parameters, and combination of the minimum number of the control parameters is used so as to perform one unit walking motion. Table 2 represents a composition example of these parameters.

TABLE 2

pr1 = p3 = rolling angle of hip roll joint
pr2 = p1 = torso inclination angle
pr3 = p4 = sweeping angle of swing hip pitch
pr4 = p5 = maximum bending angle of swing knee
pr5 = p7 = bending angle of stance ankle pitch
pr6 = tf = step time
pr7 = p3, asym = asymmetric hip rolling motion
pr8 = p4, asym = asymmetric hip pitch sweeping motion
pr9 = p7, asym = asymmetric ankle bending motion

As described above, n unit walking motions A={A1, A2, A3, . . . , An} are defined in advance and stored to construct a database 422 (see FIG. 4), and in actual walking, an objective walking pattern is generated through combination of the unit walking motions and the robot walks based on the generated objective walking pattern. Thereby, the robot may generate a dynamic walking pattern satisfying desired stride, velocity, rotating angle and direction and then walk based on the generated dynamic walking pattern.

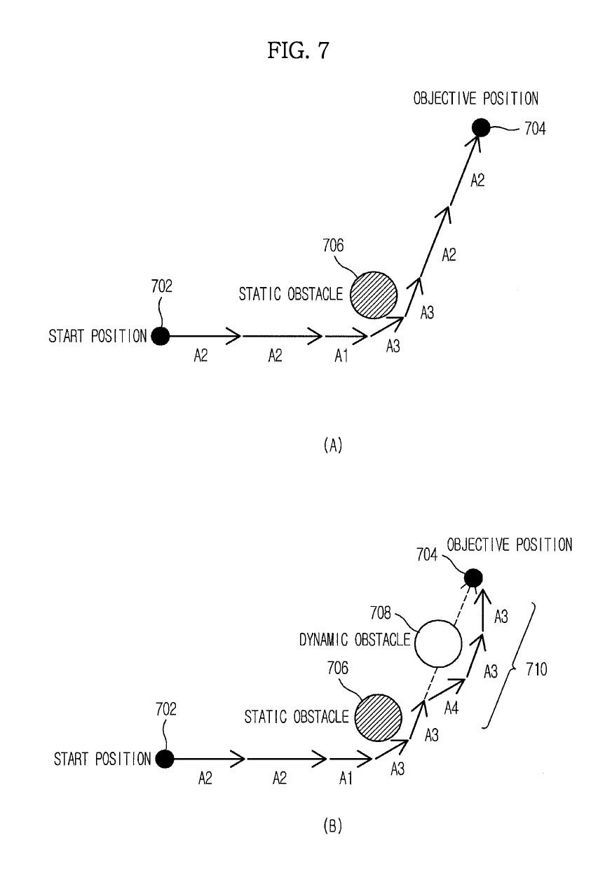

FIGS. 7A and 7B are views illustrating a walking control concept of the robot in accordance with an embodiment. In order to control the robot, a strategy to minimize the total number of steps and the total sum of rotating angles is applied and thus an objective path is expressed as a type in which multiple vectors are connected, as shown in FIGS. 7A and 7B. A size of each vector means a size of a stride (a vector having a size of zero means that the robot walks in place). If the current vector has the same direction of the former vector, the robot walks rectilinearly, and if the current vector has a direction differing from the former vector, the robot walks in a curve by a difference between the directions of the two vectors. Candidate unit walking motions to satisfy a given stride and to achieve rotation of the robot are selected from the unit walking motions stored in database. Finally, a unit walking motion from among the candidate unit walking motions, which is most similar to the former unit walking motion, is determined. Such a path interpretation method uses vectors connected in a three-dimensional space, thus being capable of being applied to a walking plan in a place in which a height of the ground is not regular.

As shown in FIG. 7A, a broad walking pattern consisting of a series of unit walking motions A2-A2-A1-A3-A3-A2-A2 to move from a start position 702 to an objective position 704 is generated, and the robot walks according to the broad walking pattern. Such a broad walking pattern is set in advance in consideration of a static obstacle 706, i.e., an obstacle in a stationary state, so as to avoid the static obstacle 706. The broad walking pattern of FIG. 7A consists of a total of three unit walking motions. The unit walking motion A2 causes the robot to proceed two steps rectilinearly with a stride of 50 cm, the unit walking motion A1 causes the robot to proceed one step rectilinearly with a stride of 25 cm, and the unit walking motion A3 causes the robot to proceed one step at an angle of 20 degrees to the left. Through combination of these three unit walking motions, the robot walks rectilinearly from the start position 702 to a position near the static obstacle 706 (A2-A2-A1), walks in a curve to avoid the static obstacle 702 (A3-A3), and then walks rectilinearly to the objective position 704 (A3-A2-A2).

If a dynamic obstacle 708, i.e., a new movable obstacle, is located on the existing walking path, as shown in FIG. 7B, the robot is incapable of avoiding the new obstacle 708 using the existing walking pattern. Therefore, modification of the walking pattern to avoid the dynamic obstacle 708 is inevitable. Unit walking motions (A4-A3-A3) indicated by reference numeral 710 in FIG. 7B represent a modified walking pattern, i.e., a local walking pattern to avoid the dynamic obstacle 708. The unit walking motion A4 causes the robot to proceed one step at an angle of 20 degrees to the right, and the unit walking motions A3 causes the robot to proceed one step at an angle of 20 degrees to the left in the same manner as FIG. 7A.

As shown in FIGS. 7A and 7B, various unit walking motions are defined in advance and stored to construct a database 422 (see FIG. 4), and in actual walking of the robot, an objective walking pattern is generated through selective combination of the unit walking motions and then the robot walks according to the objective walking pattern. Thereby, the robot may freely convert walking velocity and direction during toque control-based dynamic walking, thus walking along various paths.

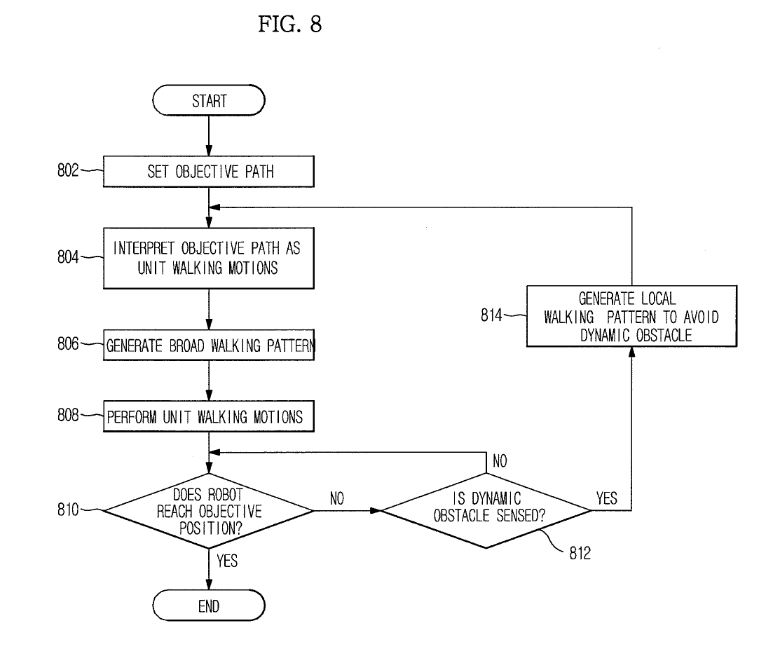

FIG. 8 is a flow chart illustrating a walking control method of the robot in accordance with an embodiment. The walking control method of FIG. 8 describes that the robot periodically senses environmental variation and performs modification (deletion or addition) of the existing broad walking pattern, as needed, while walking along a broad walking pattern to achieve an objective path. That is, an objective path is set (Operation 802). Such an objective path is a path through which the robot moves from the start position 702 to the objective position 704 of FIG. 7A. When the objective path is set, the objective path is interpreted as unit walking motions (Operation 804). That is, interpretation of the objective path as the unit walking motions to avoid the static obstacle 706 of FIG. 7A is carried out. When the interpretation of the objective path has been completed, a broad walking pattern is generated based on a result of the interpretation of the objective path (Operation 806). When the broad walking pattern is generated, the robot moves along the set path while performing the respective unit walking motions forming the broad walking pattern in order (Operation 808). When the robot reaches the objective position 704 through walking, the robot completes walking (Yes at Operation 810). On the other hand, when the robot encounters the dynamic obstacle 706 under the condition that the robot does not reach the objective position 704 (Yes at Operation 812), the robot partially modifies the broad walking pattern through generation of the local walking pattern 708 to avoid the dynamic obstacle 706 (Operation 814). Thereafter, interpretation of the objective path as unit walking motions to perform the local walking pattern 708 is carried out again (Operation 804). When the robot does not sense the dynamic obstacle 706 (No at Operation 812), the robot continuously performs the unit walking motions of the existing broad walking pattern (Operation 808).

As is apparent from the above description, in a robot and a control method thereof in accordance with an embodiment, a walking pattern having desired stride, velocity and direction is generated through optimization of actuated dynamic walking and the robot walks based on the walking pattern, thereby allowing the robot to naturally walk with high energy efficiency similar to a human.

The embodiments can be implemented in computing hardware and/or software, such as (in a non-limiting example) any computer that can store, retrieve, process and/or output data and/or communicate with other computers. For example, control unit 410 in FIG. 4 may include a computer to perform calculations and/or operations described herein. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A control method of a walking robot comprising:
defining unit walking motions, in which stride, velocity, rotating angle and direction of the robot are designated, through combination of parameters to generate target joint paths, and constructing a database in which the unit walking motions are stored;
setting an objective path up to an objective position;
performing interpretation of the objective path as unit walking motions of the unit walking motions stored in the database;
generating, by a computer, walking patterns each including at least one unit walking motion of the unit walking motions stored in the database to cause the robot to walk along the objective path based on the interpretation of the objective path; and
controlling the robot to walk based on the walking patterns.

2. The control method according to claim 1, wherein the controlling controls the robot to walk with torque control-based dynamic walking.

3. The control method according to claim 1, wherein the parameters include at least one of a parameter indicating left and right movement of hip joints of the robot, a parameter indicating inclination of a torso of the robot, a parameter indicating a stride length of the robot, a parameter indicating a bending angle of knees of the robot, a parameter indicating a walking velocity of the robot, a parameter indicating movement of ankles of the robot in the y-axis direction, a parameter indicating an initial state of the left and right movement of the hip joints of the robot, and a parameter indicating an initial state of the stride of the robot.

4. The control method according to claim 1, wherein the walking patterns include:
a broad walking pattern generated in consideration of an entirety of the objective path; and
a local walking pattern forming a part of the broad walking pattern.

5. The control method according to claim 4, wherein the broad walking pattern is a walking pattern generated in consideration of avoidance of a static obstacle recognized in advance.

6. The control method according to claim 4, wherein the local walking pattern is a walking pattern generated in consideration of avoidance of a new obstacle recognized during walking of the robot along the broad walking pattern.

7. The control method according to claim 6, wherein the local walking pattern is generated by combining unit walking motions necessary to avoid the new obstacle from among the unit walking motions stored in the database.

8. A walking robot comprising:
joints to achieve walking of the robot;
a database to store unit walking motions defined through combination of parameters to generate target joint paths, the unit walking motions designating stride, velocity, rotating angle and direction of the robot; and
a control unit to set an objective path up to an objective position, to perform interpretation of the objective path as unit walking motions of the unit walking motions stored in the database, to generate walking patterns each including at least one unit walking motion of the unit walking motions stored in the database to cause the robot to walk along the objective path based on the interpretation of the objective path, and to control the joints to cause the robot to walk based on the walking patterns.

9. The walking robot according to claim 8, wherein the control unit controls the joints to cause the robot to walk with torque control-based dynamic walking.

10. The walking robot according to claim 8, wherein the parameters include at least one of a parameter indicating left and right movement of hip joints of the robot, a parameter indicating inclination of a torso of the robot, a parameter indicating a stride length of the robot, a parameter indicating a bending angle of knees of the robot, a parameter indicating a walking velocity of the robot, a parameter indicating movement of ankles of the robot in the y-axis direction, a parameter indicating an initial state of the left and right movement of the hip joints of the robot, and a parameter indicating an initial state of the stride of the robot.

11. The walking robot according to claim 8, wherein the walking patterns include:
a broad walking pattern generated in consideration of an entirety of the objective path; and
a local walking pattern forming a part of the broad walking pattern.

12. The walking robot according to claim 11, wherein the broad walking pattern is a walking pattern generated in consideration of avoidance of a static obstacle recognized in advance.

13. The walking robot according to claim 11, wherein the local walking pattern is a walking pattern generated in consideration of avoidance of a new obstacle recognized during walking of the robot along the broad walking pattern.

14. The walking robot according to claim 13, wherein the local walking pattern is generated by combining unit walking motions necessary to avoid the new obstacle from among the unit walking motions stored in the database.
